(19) United States
(12) Patent Application Publication
(10) Pub. No.: US 2026/0171635 A1
(43) Pub. Date: Jun. 18, 2026

(54) Battery Cell and Battery Device Including the Same

(71) Applicant: SK On Co., Ltd., Seoul (KR)

(72) Inventors: Do Il PARK, Daejeon (KR); Won Tae HEO, Daejeon (KR); Do Won KIM, Yongin-si (KR)

(21) Appl. No.: 19/414,503

(22) Filed: Dec. 10, 2025

(30) Foreign Application Priority Data
Dec. 16, 2024 (KR) 10-2024-0187508

(51) Int. Cl. H01M 50/578; H01M 10/42; H01M 50/103; H01M 50/209; H01M 50/30; H01M 50/342

(52) U.S. Cl. CPC H01M 50/578; H01M 10/425; H01M 50/103; H01M 50/209; H01M 50/3425; H01M 50/394

(57) ABSTRACT

A battery cell comprises a cell housing having an accommodation portion accommodating an electrode assembly, a vent hole provided in a portion of the cell housing to communicate externally, and a venting device sealing the vent hole, wherein the venting device comprises a first venting portion communicating with the accommodation portion, a second venting portion spaced apart from the first venting portion and communicating externally, a side surface portion in which both open ends are connected to the first venting portion and the second venting portion to form a filtration space, and a filter portion disposed in the filtration space to filter gas.

### CROSS-REFERENCE TO RELATED APPLICATION(S)

This patent document claims the priority and benefits of Korean Patent Application No. 10-2024-0187508 filed on Dec. 16, 2024, the disclosure of which is incorporated herein by reference in its entirety.

### TECHNICAL FIELD

The disclosure and implementations disclosed in this patent document generally relate to a battery cell and a battery device including the same.

### BACKGROUND

Unlike primary batteries, which are used only once, secondary batteries may be recharged repeatedly and thus may be used a plurality of times.

Secondary batteries have been used in a variety of fields, such as digital cameras, mobile phones, laptops, hybrid vehicles, electric vehicles, and energy storage systems (ESS).

Secondary batteries may include lithium-ion batteries, lithium polymer batteries, lead-acid batteries, nickel-metal hydride (NiMH), nickel-cadmium (NiCd), or all-solid-state batteries.

During battery use, internal pressure may increase for various reasons. If gas is generated due to overheating, overcharging, or internal chemical reactions, the internal pressure may rapidly increase, increasing the risk of explosion. Therefore, secondary batteries are equipped with vent holes to regulate the internal pressure within battery cells.

Meanwhile, if a battery experiences thermal runaway, hydrofluoric acid (HF) gas may be generated within a battery cell. Even a small amount of HF gas leaking through the vent hole may be fatal to the human body.

Furthermore, after the battery opens the vent hole to lower the internal pressure, oxygen may be supplied to the battery cell through the open vent hole, reactivating the thermal runaway.

### SUMMARY

The present disclosure may be implemented in some embodiments to provide a battery cell and a battery device including the same, capable of filtering gas leaking through an open vent hole when the vent hole is opened.

The present disclosure may also be implemented in some embodiments to provide a battery cell and a battery device including the same, capable of minimizing the amount of oxygen flowing in through an opened vent hole after the vent hole is opened to lower internal pressure of the battery cell.

The purpose of the present disclosure is not limited to the aforementioned objectives, and other objectives not mentioned herein will be clearly understood by those skilled in the art from the following description.

In some embodiments of the present disclosure, a battery cell includes: a cell housing having an accommodation portion accommodating an electrode assembly; a vent hole provided in a portion of the cell housing to communicate externally; and a venting device sealing the vent hole, wherein the venting device includes: a first venting portion communicating with the accommodation portion; a second venting portion spaced apart from the first venting portion and communicating externally; a side surface portion in which both open ends are connected to the first venting portion and the second venting portion to form a filtration space; and a filter portion disposed in the filtration space to filter gas.

The first venting portion and the second venting portion may be ruptured at a preset pressure.

A first rupture pressure at which the first venting portion is ruptured may be set to be lower than a second rupture pressure at which the second venting portion is ruptured.

The filter portion may be disposed spaced apart from the first venting portion.

The filter portion may be a filter filtering hydrofluoric acid (HF) gas.

The battery cell may further include: an electrode terminal disposed in the cell housing and electrically connected to the electrode assembly, the electrode terminal including a first electrode terminal and a second electrode terminal having different polarities; and a circuit portion controlling current flow between the electrode terminal and the outside according to a state of the venting device.

The side surface portion may include an insulating material.

The circuit portion may operate in a first state allowing current flow between the electrode terminal and the outside or in a second state blocking current flow between the electrode terminal and the outside as the venting device is ruptured.

One of the first venting portion and the second venting portion may be electrically connected to one of the first electrode terminal and the second electrode terminal, and the other of the first venting portion and the second venting portion may be electrically connected to the other of the first electrode terminal and the second electrode terminal through the circuit portion.

The venting device may include a connection support portion supporting the filter portion to one of the first venting portion and the second venting portion.

The connection support portion may have electrical conductivity.

In the second state, the first venting portion of the venting device, which is ruptured, may contact the connection support portion so as to be electrically connected to the second venting portion.

The circuit portion may include: a switch electrically connecting an electrode tab having a first polarity to an electrode terminal having the first polarity or blocking the connection; and a coil electrically connecting the venting device to the electrode tab having the first polarity.

The switch may be opened by a current flowing through the coil in the second state to block the electrical connection between the electrode tab having the first polarity and the electrode terminal having the first polarity.

In some embodiments of the present disclosure, a battery device includes: a plurality of battery cells; a module housing accommodating the plurality of battery cells; and a controller connected to at least one of the plurality of battery cells and controlling the at least one of the plurality of battery cells, wherein at least one of the plurality of battery cells includes one of the battery cells of claims 1 to 5, and the controller outputs an error signal or blocks or limits an operation of at least one battery cell, when at least one of a current and a voltage is not detected from at least one of the plurality of battery cells.

### BRIEF DESCRIPTION OF DRAWINGS

Certain aspects, features, and advantages of the present disclosure are illustrated by the following detailed description with reference to the accompanying drawings.

FIG. 1 is a perspective view of a battery cell including a venting device according to a first embodiment of the present disclosure;

FIG. 2 is an exploded perspective view of a battery cell including a venting device according to the first embodiment of the present disclosure;

FIG. 3 is a cross-sectional view taken along line I-I′ of FIG. 1 according to the first embodiment of the present disclosure;

FIG. 4 is a perspective view illustrating a venting device according to the first embodiment of the present disclosure;

FIG. 5 is a cross-sectional view taken along line II-II′ illustrating a venting device according to the first embodiment of the present disclosure;

FIG. 6 is a conceptual diagram of a venting device including a circuit portion according to a second embodiment of the present disclosure;

FIG. 7 is a cross-sectional view of the venting device of FIG. 5 taken along line II-II′ according to the second embodiment of the present disclosure;

FIG. 8 is a circuit diagram in a first state according to the second embodiment of the present disclosure;

FIG. 9 is a circuit diagram in a second state according to the second embodiment of the present disclosure;

FIG. 10 is a circuit diagram of a venting device including a circuit portion according to a third embodiment of the present disclosure;

FIG. 11 is a diagram illustrating a battery device according to an embodiment of the present disclosure;

FIG. 12 is a perspective view of a battery cell including a venting device according to a fourth embodiment of the present disclosure;

FIG. 13 is a perspective view of a venting device according to a fifth embodiment of the present disclosure;

FIG. 14 is a perspective view of a venting device according to a sixth embodiment of the present disclosure; and

FIG. 15 is a perspective view of a venting device according to a seventh embodiment of the present disclosure.

### DETAILED DESCRIPTION

Prior to the description of the present disclosure, terms and words used in the present specification and claims to be described below should not be construed as limited to ordinary or dictionary terms, and should be construed in accordance with the technical idea of the present disclosure based on the principle that the inventors may properly define their own disclosures in terms of terms in order to best explain the disclosure. Therefore, the embodiments described in the present specification and the configurations illustrated in the drawings are merely the most preferred embodiments of the present disclosure and are not intended to represent all of the technical ideas of the present disclosure, and thus should be understood that various equivalents and modifications may be substituted at the time of the present application.

Hereinafter, preferred embodiments of the present disclosure will be described in detail with reference to the accompanying drawings. In this case, in the drawings, the same components are denoted by the same reference symbols as possible. Further, the detailed description of well-known functions and constructions which may obscure the gist of the present disclosure will be omitted. For the same reason, some of the elements in the accompanying drawings are exaggerated, omitted, or schematically illustrated, and the size of each element does not entirely reflect the actual size. In addition, in the present specification, the expressions, such as an upper side, a lower side, a side face, and the like, are described based on the drawings and may be expressed differently when the direction of the corresponding object is changed.

Hereinafter, a battery cell 10 and a battery device 700 according to the present disclosure will be described in detail with reference to the drawings.

Before describing the configuration of the battery cell 10 and the battery device 700 according to the present disclosure, it should be noted that a thickness direction of the battery cell 10 may be defined as the X-axis direction, a length direction of the battery cell 10 as the Y-axis direction, and a height direction of the battery cell 10 as the Z-axis direction.

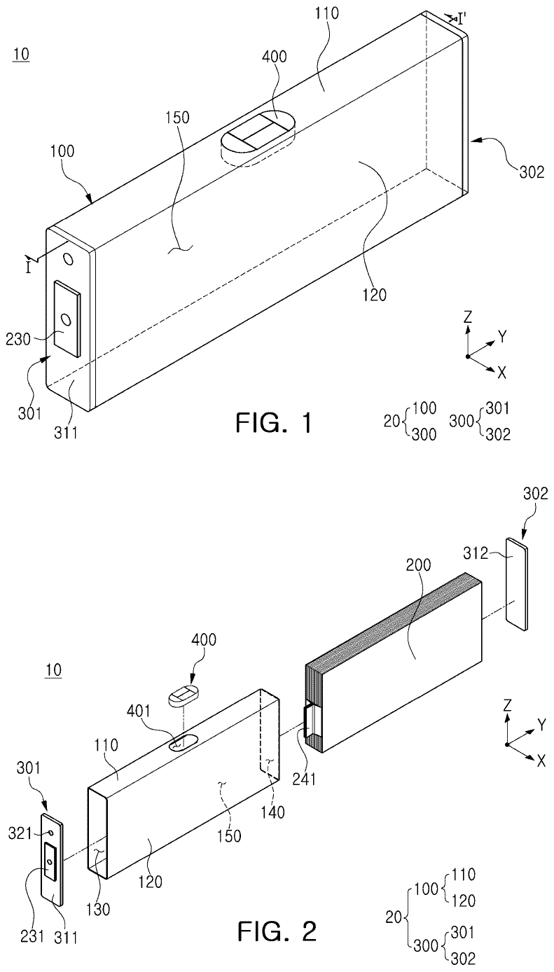

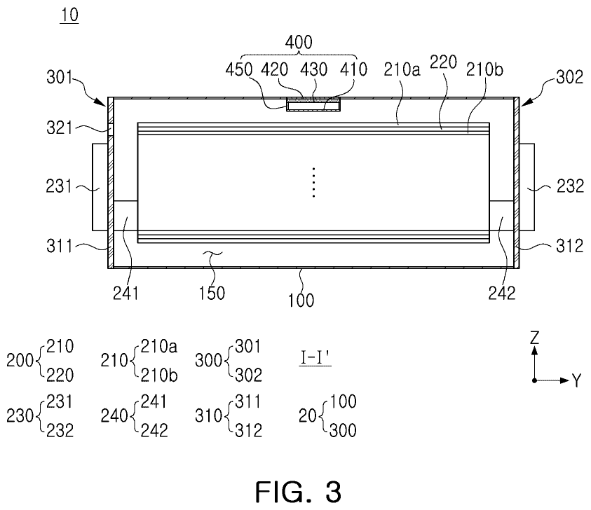

FIG. 1 is a perspective view of a battery cell 10 including a venting device 400 according to a first embodiment of the present disclosure, FIG. 2 is an exploded perspective view of the battery cell 10 including the venting device 400 according to the first embodiment of the present disclosure, and FIG. 3 is a cross-sectional view taken along line I-I′ of FIG. 1 according to the first embodiment of the present disclosure.

Referring to FIGS. 1 to 3, the battery cell 10 may include a cell housing 20 including a case 100 and a cap assembly 300, a vent hole 401 provided in a portion of the cell housing 20, and the venting device 400 provided in the vent hole 401.

Here, the cell housing 20 may be provided with an accommodation portion 150 accommodating an electrode assembly 200, and the vent hole 401 communicating externally may be provided in a portion of the cell housing 20.

The venting device 400 may seal the vent hole 401.

The venting device 400 may include a first venting portion 410 communicating with the accommodation portion 150 and a second venting portion 420 spaced apart from the first venting portion 410 and communicating externally.

Furthermore, the venting device 400 may include a side surface portion 450 connected to the first venting portion 410 and the second venting portion 420 to form a filtration space and may include a filter portion 430 disposed in the filtration space to filter gas.

The cell housing 20 may include the case 100 having a structure in which both ends thereof are open and the cap assembly 300 coupled to the open ends of the case 100.

The case 100 may form at least a portion of the cell housing 20 of the battery cell 10 and may be coupled to the cap assembly 300 to include the accommodation portion 150 accommodating the electrode assembly 200. The case 100 includes the accommodation portion 150 and may accommodate the electrode assembly 200 in the accommodation portion 150.

Here, the accommodation portion 150 may accommodate an electrolyte together with the electrode assembly 200.

The case 100 may be formed of aluminum and may be referred to as a can or housing.

The case 100 may have a substantially rectangular parallelepiped shape with at least a portion open. For example, the case 100 may have a first side surface 110 and a second side surface 120 having a width greater than the width of the first side surface 110 coupled together to form a rectangular parallelepiped shape with both ends open.

The case 100 may be formed as a hollow hexahedron extending in a longitudinal direction of the battery cell 10, including the first side surface 110 and the second side surface 120, and having both ends open.

Here, one of the both ends of the open case 100 may be referred to as a first opening 130, and the other end may be referred to as a second opening 140.

The cell housing 20 may include a pair of cap assemblies 300, and the cap assemblies 300 may be coupled to both end of the case 100, respectively.

Among the cap assemblies 300, the cap assembly 300 coupled to one end of the case 100 may be referred to as a first cap assembly 301, and the cap assembly 300 coupled to the other end may be referred to as a second cap assembly 302.

In other words, the first cap assembly 301 may seal the first opening 130 of the case 100, and the second cap assembly 302 may seal the second opening 140 of the case 100.

Referring to FIG. 3, the structure of the electrode assembly 200 will be described in more detail. The electrode assembly 200 may include an electrode plate 210, a separator 220, and an electrode tab 240.

The electrode plate 210 may include a first electrode plate and a second electrode plate having different polarities, and the separator 220 may be an insulator interposed between a negative electrode plate and a positive electrode plate.

Here, if a first electrode plate 210a is a positive electrode plate, a second electrode plate 210b may be a negative electrode plate, and if the first electrode plate 210a is a negative electrode plate, the second electrode plate 210b may be a positive electrode plate.

The electrode assembly 200 may be configured such that the first electrode plate 210a, the second electrode plate 210b having the different polarities, are repeatedly disposed.

The electrode assembly 200 may be of a winding type, a stacking type, a z-folding type, or a stack-folding type.

Each electrode plate 210 may have a structure in which a negative electrode active material or a positive electrode active material is coated on a foil.

For example, the negative electrode plate may be formed by coating a copper or nickel foil with graphite or other materials, and the positive electrode plate may be formed by coating an aluminum foil with a transition metal oxide active material.

The electrode tab 240 may be configured to electrically connect a plurality of first electrode plates 210a and a plurality of second electrode plates 210b. The first electrode tab 241 and the second electrode tab 242 each have one polarity (either positive or negative) of the anode and cathode, and they have different polarities from each other.

For example, at least two electrode tabs 240 may be provided, one of which may be electrically coupled to the first electrode plates 210a and the other may be electrically coupled to the second electrode plates 210b.

Here, the electrode tab 240 electrically coupled to the first electrode plates 210a may be referred to as a first electrode tab 241, and the electrode tab 240 electrically coupled to the second electrode plates 210b may be referred to as a second electrode tab 242.

The cap assembly 300 may include a cap plate 310 coupled to the case 100 to seal the case 100 with at least one open side.

The cap plate 310 may be formed of aluminum or a material including aluminum. The cap plate 310 may be laser-welded to the case 100 along the edge portion thereof.

The cap plate 310 provided on either the first cap assembly 301 or the second cap assembly 302 may include an electrolyte injection port 321 for injecting electrolyte into the cell housing 20.

Here, the electrolyte injection port 321 may be sealed with a stopper or the like after the electrolyte is injected.

Here, the cap plate 310 coupled to the first cap assembly 301 may be referred to as a first cap plate 311, and the cap plate coupled to the second cap assembly 302 may be referred to as a second cap plate 312.

The cap assembly 300 may include an electrode terminal 230 provided on the opposite side of the surface of the cap plate 310 facing the interior of the case 100.

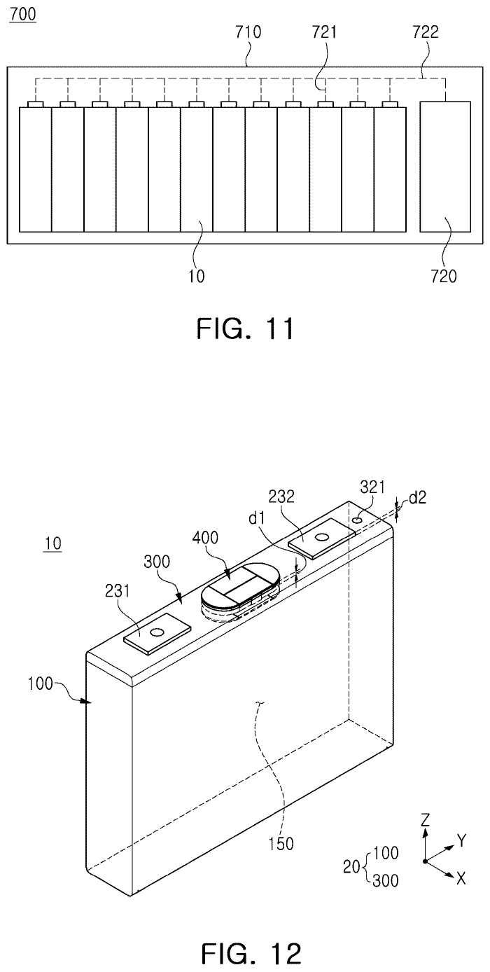

Referring to FIG. 11, when forming a module or pack, the battery cell 10 may be electrically connected to adjacent battery cells 10 via the electrode terminal 230. FIG. 11 is a diagram illustrating a battery device according to an embodiment of the present disclosure.

Here, the electrode terminal 230 may have either a positive or negative polarity. The electrode terminal 230 may include a first electrode terminal 231 and a second electrode terminal 232. The first electrode terminal 231 and the second electrode terminal 232 each have one polarity (either the anode or the cathode), and they have different polarities from each other.

For example, the first electrode terminal 231 disposed on the first cap assembly 301 may have a negative polarity, and the second electrode terminal 232 disposed on the second cap assembly 302 may have a positive polarity.

Here, the first electrode terminal 231 may be electrically connected to the negative electrode plate via the first electrode tab 241, and the second electrode terminal 232 may be electrically connected to the positive electrode plate via the second electrode tab 242.

Furthermore, the first electrode terminal 231 disposed on the first cap assembly 301 may have a positive polarity, and the second electrode terminal 232 disposed on the second cap assembly 302 may have a negative polarity.

Here, the first electrode terminal 231 may be electrically connected to the positive electrode plate via the first electrode tab 241, and the second electrode terminal 232 may be electrically connected to the negative electrode plate via the second electrode tab 242.

The components of the cap assembly 300 described above are merely an example. Therefore, some of the components of the cap assembly 300 may be omitted, or other components that are not described may be added.

At least one surface of the cell housing 20 may be provided with the vent hole 401 through which internal gas from the case 100 may be released.

For example, the vent hole 401 may be provided on the first side surface (110, see FIG. 1) of the case 100 or on the cap plate (310, see FIG. 12).

Here, the vent hole 401 may be sealed by the venting device 400 in a normal state (a first state).

Referring to FIG. 1, in the cell housing 20, the first cap assembly 301, the second cap assembly 302, the first side surface 110, and the second side surface 120 may be coupled together so that the interior of the cell housing may be sealed.

The vent hole 401 is provided in at least one of the first side surface 110, the second side surface 120, the first cap assembly 301, and the second cap assembly 302 to connect the interior and exterior of the case 100.

During battery use, gas may be generated within the battery cell 10 due to external impact, overcharging, etc., and the generated gas may increase the pressure within the battery cell 10, thereby degrading the performance of the battery cell 10 or causing damage to the battery cell 10.

Accordingly, it is preferable to remove or discharge gas generated within the battery cell 10 to the outside of the battery cell 10 through the vent hole 401.

The vent hole 401 may be formed as a hole. The shape of the hole may vary, and gas or flames generated within the battery cell 10 may be discharged to the outside through the vent hole 401.

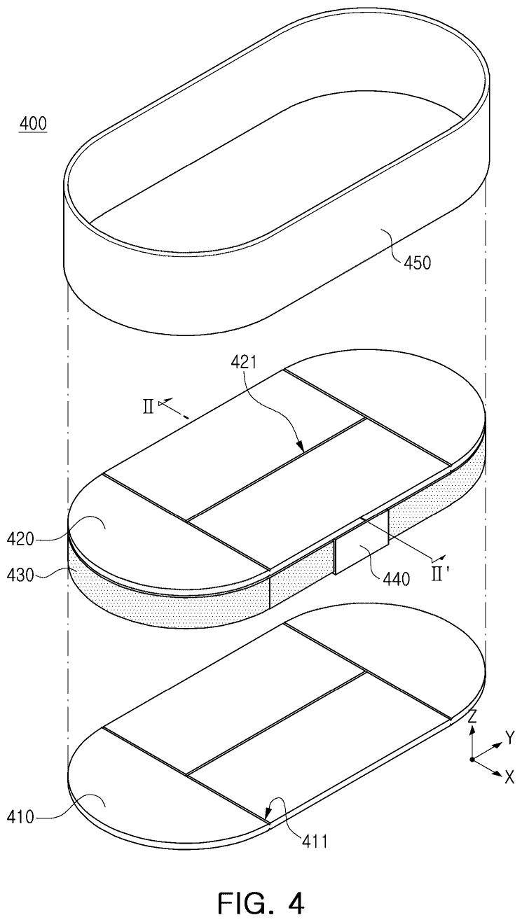

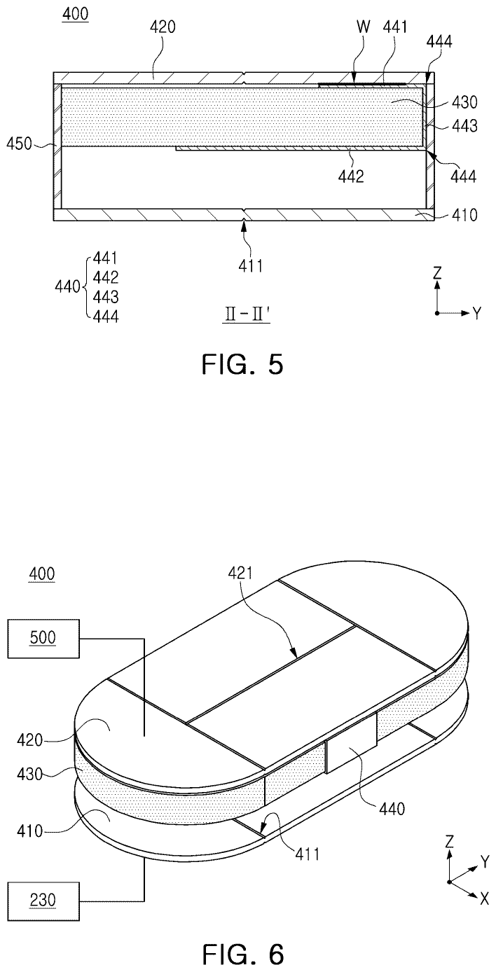

FIG. 4 is a perspective view illustrating the venting device 400 according to the first embodiment of the present disclosure, and FIG. 5 is a cross-sectional view taken along line II-II′ illustrating the venting device 400 according to the first embodiment of the present disclosure.

Hereinafter, the internal structure of the venting device 400 will be described in more detail with reference to FIGS. 4 and 5 together with FIGS. 1 to 3.

The first state may be a normal state in which the venting device 400 is not ruptured, and a second state may be a state in which at least the first venting portion is ruptured due to gas generated within the battery cell 10.

The venting device 400 may seal the vent hole. The venting device may be provided in the vent hole 401 and may seal the vent hole 401 opened in the normal state (the first state).

Meanwhile, the venting device 400 may be ruptured when gas is generated within the battery cell 10 and the pressure within the battery cell 10 increases. When the venting device 400 is ruptured, the vent hole 401 may be opened, allowing gas generated within the battery cell 10 to be released to the outside through the vent hole 401, thereby reducing the internal pressure of the battery cell 10.

Here, the vent hole 401 is provided to penetrate through the battery cell 10, thereby providing a path for gas generated within the battery cell 10 to be released to the outside of the battery cell 10.

Referring to FIG. 4, the venting device 400 may include the first venting portion 410, the second venting portion 420, the side surface portion 450, and the filter portion 430.

The venting device 400 may include the first venting portion 410 provided on the inside of the cell housing 20 (e.g., on the inside of the cap plate 310), the second venting portion 420 provided on the outside of the cell housing 20 (e.g., on the outside of the cap plate 310), and the side surface portion 450 coupled to the first venting portion 410 and the second venting portion 420 to form a filtration space.

The venting device 400 may include two venting portions that may be ruptured due to external conditions.

In other words, the venting device 400 may include the first venting portion 410 and the second venting portion 420. The first venting portion 410 may be provided closer to the center of the cell housing 20 (e.g., closer to the accommodation portion 150) and the second venting portion 420 may be provided on the outside of the cell housing 20.

The side surface portion 450 may be in the form of a tube with both ends open, and the open ends may be connected to the first venting portion 410 and the second venting portion 420, respectively.

The first venting portion 410, the second venting portion 420, and the side surface portion 450 may be coupled to form a filtration space.

The first venting portion 410 and the second venting portion 420 may be ruptured at a pressure equal to or higher than a preset pressure. The first venting portion 410 and the second venting portion 420 may each include a rupture portion.

For example, the rupture portion may be formed thinner than other portions of the first venting portion 410 or the second venting portion 420. By adjusting the thickness of the rupture portion, the first venting portion 410 or the second venting portion 420 may be ruptured at a pressure equal to or higher than the preset pressure.

The rupture portion provided in the first venting portion 410 may be referred to as a first rupture portion 411, and the pressure set to cause the first rupture portion 411 to be ruptured may be referred to as a first rupture pressure.

The shapes of the first rupture portion 411 or the second rupture portion 421 may vary.

Referring to FIG. 4, the first rupture portion 411 may be configured to opened by rotating about two axes formed in the Y-direction.

More specifically, the first rupture portion 411 may include two grooves spaced apart from each other and extending in the X-direction and a groove connecting the two grooves and extending in the Y-direction. The three grooves may be provided to form an overall “H” shape.

Here, when a pressure equal to or higher than the first rupture pressure is applied to the first venting portion 410, one groove extending in the Y-direction may be ruptured and opened and may be bent to both sides so as to be opened.

The second venting portion 420 may be formed on the outside of the cap plate 310, facing the first venting portion 410. The second venting portion 420 may be configured to be ruptured at a pressure higher than the first rupture pressure.

Here, the first venting portion 410 and the second venting portion 420 may be spaced apart from each other and connected.

For example, the first venting portion 410 and the second venting portion 420 may form a sealed space, and the filter portion 430 may be provided within the sealed space.

Here, the first venting portion 410 and the second venting portion 420 may be connected to each other via the side surface portion 450 connecting the respective edges, thereby forming the sealed space.

However, the present disclosure is not limited thereto, and various methods may be applied to form the sealed space while providing the filter portion 430 within the first venting portion 410 and the second venting portion 420.

For example, the first venting portion 410 may be connected to one surface of the cap plate 310, and the other surface may be connected to the other surface of the second venting portion 420, so that the first venting portion 410 and the second venting portion 420 may be connected with the cap plate 310 to form a sealed space.

The second venting portion 420, like the first venting portion 410, may further include the second rupture portion 421 guiding a rupture pattern of the second venting portion 420.

The second rupture portion 421 may be configured to be ruptured at a pressure equal to or higher than a second rupture pressure, thereby opening the second venting portion 420. The second rupture pressure may be set to be greater than the first rupture pressure.

The first rupture pressure at which the first venting portion is ruptured may be set to be lower than the second rupture pressure at which the second venting portion is ruptured.

By setting the first rupture pressure to be lower than the second rupture pressure, the first venting portion 410 may be ruptured before the second venting portion 420, thereby securing a vent buffer.

Through the vent buffer, the time for the gas inside the battery cell 10 to be in contact with the filter portion 430 may be increased, thereby improving filtration efficiency.

In addition, since the vent hole 401 is sealed using the two venting portions, i.e., the first venting portion 410 and the second venting portion 420, the problem of the related art in which the vent hole 401, which is sealed with only one venting portion, is easily opened due to minor impact, may be resolved.

Referring to FIGS. 4 and 5, the venting device 400 may further include the filter portion 430 provided between the first venting portion 410 and the second venting portion 420.

If the first venting portion 410 is ruptured, the filter portion 430 may capture harmful gases generated inside the battery cell 10.

Here, the filter portion 430 may include a filter filtering hydrofluoric acid (HF) gas.

Furthermore, in a case in which the first venting portion 410 and the second venting portion 420 are ruptured, air from outside the battery cell 10 may enter through the filter portion 430. In this case, since the filter portion 430 acts as flow resistance for air flowing from the outside of the venting device 400 into the inside of the battery cell 10, oxygen included in the air from entering the inside of the battery cell 10 may be minimized and an exothermic reaction inside the battery cell 10 may be delayed.

The filter portion 430 may be provided between the first venting portion 410 and the second venting portion 420, and the thickness of the filter portion 430 may be smaller than the distance between the first venting portion 410 and the second venting portion 420.

In other words, the filter portion 430 may be provided to contact either the first venting portion 410 or the second venting portion 420.

For example, the filter portion 430 may be provided to contact the second venting portion 420 but not contact the first venting portion 410 with a predetermined gap therebetween.

The filter portion 430 may be disposed to be spaced apart from the first venting portion 410.

When the filter portion 430 is provided in contact with the first venting portion 410, the filter portion 430 may prevent the first venting portion 410 from being ruptured and may cause the first rupture portion 411 to be ruptured at a pressure higher than the first rupture pressure.

Therefore, the filter portion 430 is preferably provided spaced apart from the first venting portion 410 but is not limited thereto.

Furthermore, in the venting device 400, the filter portion may be supported on either the first venting portion or the second venting portion. A connection support portion may support the filter portion 430 provided between the first venting portion 410 and the second venting portion 420.

A connection support portion 440 may include a first support portion 441, a second support portion 442, and a third support portion 443 connected via two bent portions 444.

One surface of the first support portion 441 may be coupled (W) to the first venting portion 410 or the second venting portion 420, and the other surface thereof may be in contact with the filter portion 430.

When the second support portion 442 is disposed to face the first support portion 441, one surface of the second support portion 442 may be in contact with the filter portion 430 and the other surface thereof may be disposed spaced apart from the first venting portion 410 or the second venting portion 420 in a facing manner, thereby supporting the filter portion 430 to maintain a gap with the first venting portion 410 or the second venting portion 420.

The third support portion 443 may be connected to the first support portion 441 and the second support portion 442 by means of bent portions 444 at both ends, thereby connecting the first support portion 441 and the second support portion 442.

Here, the connection support portion 440 may include the first support portion 441, the second support portion 442, and the third support portion 443 and have one side opened, so that the filter portion 430 may be inserted into the opened side, so that the filter portion 430 and the second venting portion 420 may be easily assembled.

The venting device 400 according to the first embodiment of the present disclosure may double-seals the vent hole 401 formed in a portion of the cell housing 20 using the first venting portion 410 and the second venting portion 420, thereby preventing the vent hole 401 from opening due to minor impacts.

Furthermore, the first rupture pressure at which the first venting portion 410 located to be adjacent to the accommodation portion 150 of the cell housing 20 is ruptured may be set to be lower than the second rupture pressure at which the second venting portion 420 is ruptured, so that a time difference between the rupture times of the first venting portion 410 and the second venting portion 420 may be made, through which the time for harmful gases within the battery cell 10 to be in contact with the filter portion 430 may increase, thereby enhancing the effectiveness of the filter portion 430.

Furthermore, even after both the first venting portion 410 and the second venting portion 420 are ruptured, air including oxygen from outside the battery cell 10 may be introduced through the filter, thereby minimizing the amount of oxygen introduced into the battery cell 10.

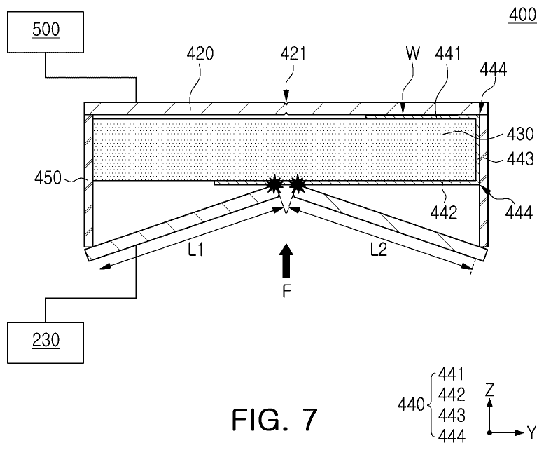

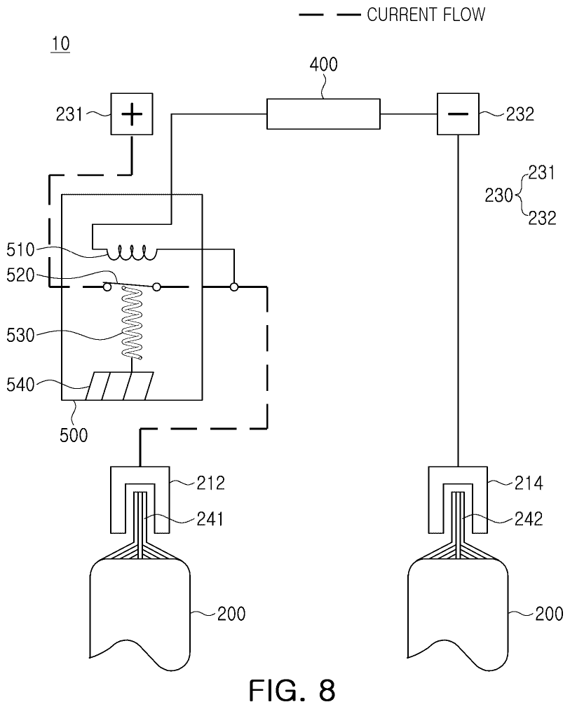

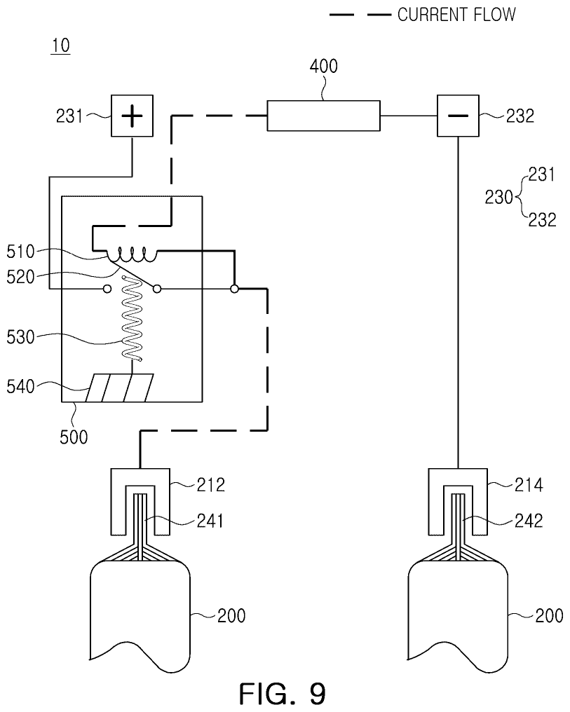

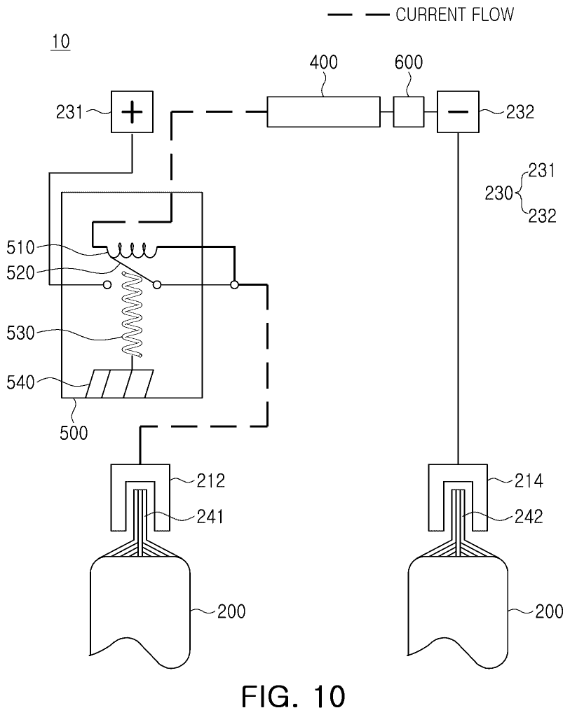

FIG. 6 is a conceptual diagram of the venting device 400 including a circuit portion 500 according to a second embodiment of the present disclosure, FIG. 7 is a cross-sectional view taken along line II-II′ of the venting device 400 of FIG. 5 according to the second embodiment of the present disclosure, FIG. 8 is a cross-sectional view taken along line II-II′ of the venting portion of FIG. 5 in a second state according to the second embodiment of the present disclosure, FIG. 9 is a circuit diagram in a first state according to the second embodiment of the present disclosure, and FIG. 10 is a circuit diagram in the second state according to the second embodiment of the present disclosure.

Referring to FIGS. 6 to 10, the battery cell 10 according to the second embodiment of the present disclosure may include the electrode terminal 230 disposed in the cell housing 20, electrically connected to an electrode assembly 200, and including the first electrode terminal 231 and the second electrode terminal 232 having different polarities.

Furthermore, the battery cell 10 may include the circuit portion 500 regulating current flow between the electrode terminal 230 and the outside, depending on the state of the venting device 400.

The circuit portion 500 may operate in the first state allowing current flow between the electrode terminal 230 and the outside or in the second state blocking current flow between the electrode terminal 230 and the outside when the venting device 400 is ruptured.

Here, the first state may be a normal state in which the venting device 400 is not ruptured, and the second state may be a state in which at least the first venting device is ruptured due to gas generated within the battery cell 10.

In the first state, the circuit portion 500 may electrically connect the electrode assembly 200 and the electrode terminal 230, and in the second state, the circuit portion 500 may at least partially block the electrical connection between the electrode assembly 200 and the electrode terminal 230.

The electrode terminal 230 may include the first electrode terminal 231 (e.g., a cathode terminal) electrically connected to the first electrode tab 241 (e.g., a cathode electrode tab) of the electrode assembly 200 and the second electrode terminal 232 (e.g., an anode terminal) electrically connected to the second electrode tab 242 (e.g., an anode electrode tab) of the electrode assembly 200.

The first electrode tab 241 (e.g., the cathode electrode tab) may be electrically connected to the first electrode terminal 231 (e.g., the cathode terminal) via a first connector 212 (e.g., a cathode connector), and the second electrode tab 242 (e.g., the anode electrode tab) may be electrically connected to the second electrode terminal 232 (e.g., the anode terminal) via a second connector 214 (e.g., an anode connector).

Here, for convenience, FIGS. 8 through 10 illustrate the first electrode tab 241 and the second electrode tab 242 respectively connected to the electrode assembly 200. However, the first electrode tab 241 and the second electrode tab 242 may extend from the same electrode assembly 200.

Hereinafter, the first electrode terminal 231 may be a cathode terminal, the first electrode tab 241 may be a cathode electrode tab, the first connector 212 may be a cathode connector, the second electrode terminal 232 may be an anode terminal, the second electrode tab 242 may be an anode electrode tab, and the second connector 214 may be an anode connector.

Referring to FIG. 7, the second venting portion 420 may be connected to the circuit portion 500, and the first venting portion 410 may be connected to either the first electrode terminal 231 or the second electrode terminal 232.

One of the first venting portion 410 and the second venting portion 420 may be electrically connected to one of the first electrode terminal 231 and the second electrode terminal 232.

In addition, the other of the first venting portion 410 and the second venting portion 420 may be electrically connected to the other of the first electrode terminal 231 and the second electrode terminal 232 via the circuit portion.

Here, the first venting portion 410 and the circuit portion 500 may be connected to different electrode terminals. For example, when the first venting portion 410 is connected to the first electrode terminal 231 or the second electrode terminal 232, the circuit portion 500 may be connected to the second electrode terminal 232 or the first electrode terminal 231.

Hereinafter, a case in which the first venting portion 410 is connected to the second electrode terminal 232 and the circuit portion 500 is connected to the first electrode terminal 231 is described with reference to FIGS. 8 to 10.

Meanwhile, unless there are special circumstances, the first venting portion 410 and the second venting portion 420 are spaced apart from each other, and thus, the first venting portion 410 and the second venting portion 420 may remain electrically disconnected.

Referring back to FIG. 7, when the first venting portion 410 is ruptured due to gas or the like within the battery cell, the first venting portion 410 may be ruptured to the second venting portion 420 due to the force F caused by the internal gas pressure.

The first venting portion 410 may be partially opened to both sides of the first venting portion 410 with predetermined lengths L1 and L2 depending on the shape of the first rupture portion and may contact the connection support portion 440.

The connection support portion 440 may support the filter portion 430 on one of the first venting portion 410 and the second venting portion 420.

Here, the connection support portion 440 may have electrical conductivity. Therefore, the connection support portion 440 supported on the second venting portion 420 may contact the first venting portion 410, thereby electrically connecting the first venting portion 410 and the second venting portion 420.

Here, the lengths L1 and L2 of the first venting portion 410 opened apart to both sides may be equal or different. However, even when the lengths L1 and L2 of the first venting portion 410 are different, the lengths by which the venting portion 410 is opened may be provided to be sufficient to ensure contact with the connection support portion 440.

Meanwhile, the side surface portion 450 according to the second embodiment of the present disclosure may include an insulating material and may insulate the first venting portion 410 and the second venting portion 420.

In other words, in the battery cell 10 including the circuit portion 500, in the second state in which the first venting portion 410 is ruptured, the first venting portion 410 and the second venting portion 420 may need to be electrically connected. Conversely, in the first state, the first venting portion 410 and the second venting portion 420 may not need to be electrically connected.

Therefore, the side surface portion 450 connected to the first venting portion 410 and the second venting portion 420 may be formed of an insulating material blocking electrical connection, thereby preventing electrical connection between the first venting portion 410 and the second venting portion 420 in the first state.

Referring to FIG. 8, in the first state, the circuit portion 500 may electrically connect the first electrode terminal 231 and the first electrode tab 241, or electrically connect the second electrode terminal 232 and the second electrode tab 242, and the venting device 400 may not be electrically connected to the circuit portion 500.

Referring to FIG. 9, in the first state, the circuit portion 500 may block the electrical connection between the first electrode terminal 231 and the first electrode tab 241 or block the electrical connection between the second electrode terminal 232 and the second electrode tab 242, and the venting device 400 may be electrically connected to the circuit portion 500.

In the first state, the venting device 400 may be configured such that the first venting portion 410 does not contact the connection support portion 440 or the second venting portion 420 and the first venting portion 410 and the second venting portion 420 are not electrically connected to each other.

If pressure equal to or higher than the first rupture pressure occurs within the battery cell 10, the first venting portion 410 in the venting device 400 may rupture toward the second venting portion 420, so that a portion of the first venting portion 410 may be electrically connected to the second venting portion 420 via the connection support portion 440 and the circuit portion 500 may be switched from the first state to the second state.

In the second state, in the venting device 400, the ruptured first venting portion 410 may contact the connection support portion 440 and may be electrically connected to the second venting portion 420.

Referring back to FIG. 6, one of the first venting portion 410 and the second venting portion 420 may be electrically connected to the electrode terminal 230, and the other thereof may be electrically connected to the circuit portion 500.

Referring to FIG. 6 and FIGS. 8 to 10, the first venting portion 410 may be electrically connected to the second electrode terminal 232, and the second venting portion 420 may be electrically connected to the first electrode terminal 231. The opposite connection is also possible.

The circuit portion 500 may include a switch 520 and a coil 510 functioning to connect to the first state or the second state.

In other words, the circuit portion 500 may include the switch 520 electrically connecting the first electrode tab 241 to the first electrode terminal 231 or blocking the connection.

Furthermore, the circuit portion 500 may include the coil 510 electrically connecting the venting device 400 to the first electrode tab 241.

Here, the switch 520 may be a relay, and the relay may be configured to turn the switch 520 on or off depending on conditions.

In the first state, the switch 520 may electrically connect the first electrode tab 241 and the first electrode terminal 231, allowing current to flow between the first electrode tab 241 and the first electrode terminal 231.

Here, the venting device 400 may be connected to the second electrode terminal 232 and the coil 510.

In other words, in the first state, the circuit portion 500 may be connected to the venting device 400, which is connected to the second electrode terminal 232 via the coil 510.

However, since the first venting portion 410 and the second venting portion 420 of the venting device 400 are not electrically connected to each other, the circuit portion 500 may not be electrically connected to the second electrode terminal 232.

Referring to FIGS. 9 and 10, in the second state, the first venting portion 410 and the second venting portion 420 of the venting device 400 are connected to each other, the coil 510 may be disposed between the venting device 400 and the first electrode tab 241, and current may be applied to the venting device 400 and the coil 510.

In other words, in the second state, the coil 510 may be electrically connected between the first electrode tab 241 and the second electrode terminal 232.

Here, when current is supplied to the coil 510, the coil 510 may be magnetized.

In the second state in which the first venting portion 410 and the second venting portion 420 are connected, the switch 520 may be disconnected by the current flowing through the coil 510, thereby blocking the electrical connection between the first electrode tab 241 and the first electrode terminal 231.

Here, the switch 520 may have magnetic properties so as to be moved by the magnetized coil 510.

For example, the venting device 400 may have one end electrically connected to the second electrode terminal 232 and the other end electrically connected to the coil 510 of the circuit portion 500. Furthermore, the switch 520 may have one end electrically connected to the first electrode terminal 231 and the other end electrically connected to the first electrode tab 241.

Accordingly, the switch 520 may be opened by the current flowing through the coil 510 in the second state, thereby blocking the electrical connection between the first electrode tab 241 and the first electrode terminal 231.

Referring to FIG. 8, in the first state, the venting device 400 may have an open circuit as the first venting portion 410 and the second venting portion 420 or the connection support portion 440 are not in contact with each other, thereby blocking the current flow through the venting device 400.

Conversely, as illustrated by the dotted line, the current may flow to the first electrode terminal 231 through the first electrode tab 241 of the electrode assembly 200, the first connector 212, and the switch 520.

In other words, in the first state, the circuit portion 500 allows current flow between the first electrode tab 241 and the first electrode terminal 231, and thus, current may flow between the first electrode terminal 231 and the outside.

The circuit portion 500 may include an elastic member 530 (e.g., a spring) providing elasticity to stably maintain the switch 520 in a connected state in the first state.

Here, the elastic member 530 may provide elasticity to the switch 520 to maintain the first electrode tab 241 electrically connected to the first electrode terminal 231. One end of the elastic member 530 may be supported by an elastic member support portion 540, and the other end of the elastic member 530 may be coupled to the switch 520.

In the first state, the connection of the switch 520 may be maintained due to the elasticity of the elastic member 530, even in situations in which external vibrations or impact occurs.

Referring to FIG. 9 along with FIG. 7, when the first venting portion 410 is ruptured and comes into contact with the second venting portion 420 due to an increased internal pressure of the battery cell 10, the first venting portion 410 and the second venting portion 420 may form a closed circuit.

In the second state, the first venting portion 410 and the second venting portion 420 may be connected so that current may flow through the venting device 400 and the coil 510 may also be electrically connected to the second electrode terminal 232 through the venting device 400.

Here, when current flows through the coil 510, the coil 510 may become magnetized and the switch 520, having magnetic properties, may be opened. As the switch 520 is opened, the current flow between the first electrode tab 241 and the first electrode terminal 231 of the electrode assembly 200 may be blocked.

In other words, in the second state, the circuit portion 500 may block the current flow between the first electrode tab 241 and the first electrode terminal 231, thereby blocking the current flow between the electrode terminal 230 and the outside.

When the current flow between the electrode terminal 230 and the outside is blocked, a battery management system (e.g., a controller 720 of FIG. 11) may detect a defect in the battery cell 10.

In the second state, the switch 520 may be switched to a disconnected state by the magnetized coil 510, and the magnetic force applied to the coil 510 and the switch 520 may have a value greater than that of the elastic member 530, thereby changing the state of the switch 520.

Alternatively, a notch or hook may be provided below the coil 510 through which the switch 520 has to pass when attracted by the coil 510 in a case in which the coil 510 is magnetized. The notch or hook may help prevent the switch 520 from reconnecting when current to the coil is blocked so the coil 510 is not magnetized.

Referring to FIG. 10, the venting device 400 according to a third embodiment of the present disclosure may further include a current limiting portion 600 in the venting device 400 according to the second embodiment.

Here, the current limiting portion 600 may be disposed in series with the venting device 400 to limit the current flowing through the coil 510 beyond a set value. For example, the current limiting portion 600 may be disposed between the venting device 400 and the second electrode terminal 232.

The current limiting portion 600 may prevent the coil 510 from being shorted due to excessive current. For example, the current limiting portion 600 may be a resistor.

FIG. 11 is a diagram illustrating a battery device 700 according to an embodiment of the present disclosure.

Referring to FIG. 11, the battery device 700 according to an embodiment of the present disclosure may include a plurality of battery cells 10, a module housing 710 accommodating the plurality of battery cells 10, and a controller 720 connected to at least one of the plurality of battery cells and controlling at least one of the plurality of battery cells.

At least one of the plurality of battery cells 10 may include one of the battery cells 10 according to various embodiments of the present disclosure.

The controller 720 may output an error signal or block or limit the operation of at least one battery cell 10 if at least one of current and voltage is not detected from at least one of the plurality of battery cells 10.

The venting device 400 may operate to block current flow between the electrode terminal 230 and the outside by rupturing the first venting portion 410 due to changes in internal pressure within the battery cell 10.

The module housing 710 may further include a component (not illustrated) dissipating heat generated by each battery cell 10 or cooling the battery cell 10. The module housing 710 may further include a component (not illustrated) discharging gases emitted from the battery cell 10 externally.

Furthermore, the plurality of battery cells 10 may include the circuit portion 500, and the circuit portion 500 may be electrically connected to the venting device 400 and the electrode terminal 230.

The circuit portion 500 may normally operate to allow current flow between the electrode terminal 230 and the outside. If an event occurs in the battery cell 10, such as an event increasing the pressure inside the battery cell 10, the circuit portion 500 may operate in the second state blocking current flow between the electrode terminal 230 and the outside according to the operation of the venting device 400.

The controller 720 may include a battery management system (BMS) or may be configured as part of the BMS. The controller 720 may be connected to at least one of the plurality of battery cells 10 via a signal line.

Here, the signal line may include a first line 721 connected to the plurality of battery cells 10 and a second line 722 connected to the controller 720. The second line 722 may be connected to the first line 721 to detect an output voltage of the plurality of battery cells 10.

If at least one of the current and voltage is not detected from at least one of the plurality of battery cells 10, the controller 720 may output an error signal or block or limit the operation of at least one battery cell 10.

For example, if at least one of current and voltage is not detected in at least one battery cell 10, the controller 720 may interpret this as that the venting device 400 operates due to an increased internal pressure within the battery cell 10.

Accordingly, the controller 720 may perform a series of controls to delay or prevent thermal runaway in the plurality of battery cells 10 disposed within the battery device 700.

For example, the controller 720 may block or limit the use of the battery cell 10 with increased pressure and the nearby battery cells 10 among the plurality of battery cells disposed within the battery device 700.

Furthermore, the controller 720 may also block or limit the operation of all of the plurality of battery cells 10 disposed within the battery device 700.

The functions performed in the processes and methods may be implemented in different orders. Furthermore, the outlined operations are provided only as examples, and some of the operations may be optional, combined with fewer operations, or expanded to additional operations without damaging the essence of the disclosed embodiments.

FIG. 12 is a perspective view of the battery cell 10 including the venting device 400 according to a fourth embodiment of the present disclosure.

Referring to FIG. 12, the venting device 400 according to the fourth embodiment of the present disclosure may be provided in a unidirectional battery cell 10. For example, the venting device 400 according to the fourth embodiment of the present disclosure may be provided in the cap assembly 300 of the unidirectional battery cell 10.

For example, the first venting portion 410 may be connected to the surface of the cap plate adjacent to the accommodation portion, and the second venting portion 420 may be connected to the outer surface of the cap plate.

Alternatively, the first venting portion 410 may be provided on an insulating member provided between the electrode terminal and the cap plate, and the second venting portion 420 may be provided on the cap plate.

Here, the venting device 400 according to the fourth embodiment may be provided to protrude outwardly from the cell housing 20.

Here, the height at which the venting device 400 protrudes outwardly from the battery cell 10 may be referred to as a first step d1, and the protruding heights of the first electrode terminal 231 and second electrode terminal 232 provided on both sides of the venting device 400 may be referred to as a second step d2. It is preferable that the first step d1 be smaller than the second step d2.

However, the present disclosure is not limited thereto, and the venting device 400 according to the fourth embodiment may be provided without a step from the outer surface of the cell housing 20.

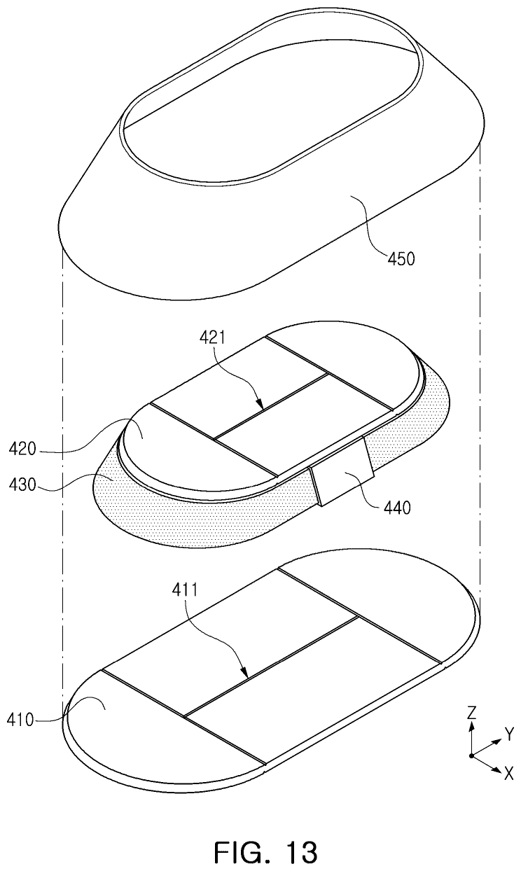

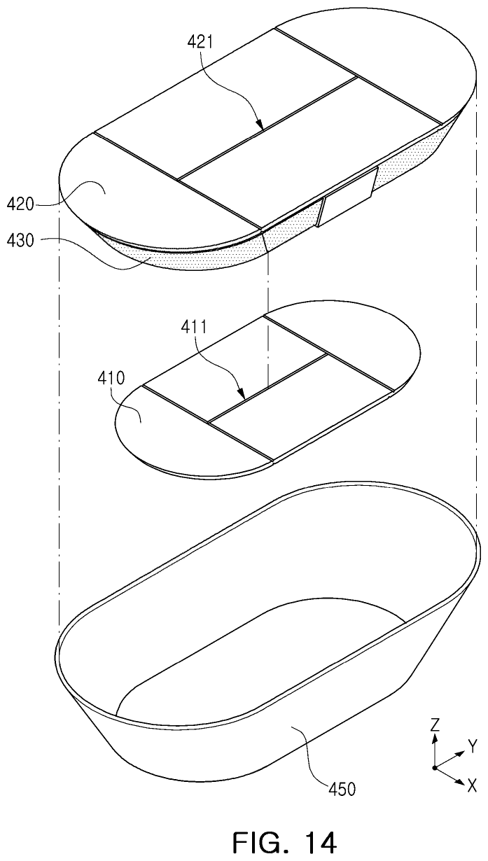

FIG. 13 is a perspective view of the venting device 400 according to a fifth embodiment of the present disclosure, and FIG. 14 is a perspective view of the venting device 400 according to a sixth embodiment of the present disclosure.

Referring to FIGS. 13 and 14, the venting devices 400 according to the fifth and sixth embodiments of the present disclosure may have different sizes for the first venting portion 410 and the second venting portion 420.

Referring to FIG. 13, in the venting device 400 according to the fifth embodiment of the present disclosure, the area of the first venting portion 410 may be less than the area of the second venting portion 420. Referring to FIG. 14, in the venting device 400 according to the sixth embodiment of the present disclosure, the area of the first venting portion 410 may be greater than the area of the second venting portion 420.

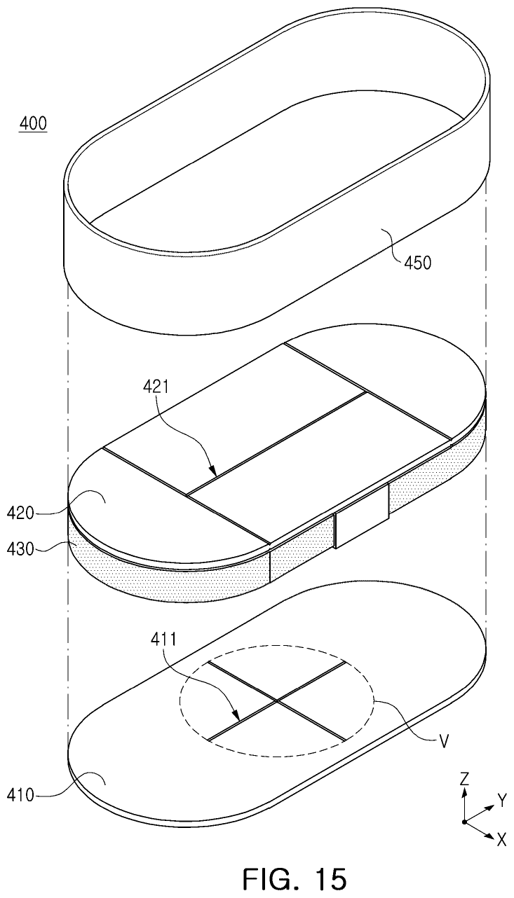

FIG. 15 is a perspective view of the venting device 400 according to a seventh embodiment of the present disclosure.

Referring to FIG. 15, in the venting device 400 according to the seventh embodiment of the present disclosure, rupture directions and sizes of the first venting portion 410 and the second venting portion 420 may be different from each other.

For example, by providing the first venting portion 410 in the X and Y-directions, the first rupture portion 411 of the first venting portion 410 may be bent and ruptured in a roughly circular (V) shape to open the first venting portion 410.

The opening directions of the first venting portion 410 and the second venting portion 420 may be set to vary by using the shapes of the first rupture portion 411 provided in the first venting portion 410 and the second rupture portion 421 provided in the second venting portion 420.

According to an embodiment of the present disclosure, when the vent hole is opened, gases harmful to the human body may be filtered and discharged through the opened vent hole.

Furthermore, according to an embodiment of the present disclosure, after the vent hole is opened and the internal pressure of the battery cell is lowered, the amount of oxygen flowing through the opened vent hole may be minimized, thereby delaying or preventing further thermal runaway.

The battery cell and the battery device including the same according to the present disclosure may be widely applied to devices in green technology fields, such as electric vehicles, battery charging stations, and other battery-based solar and wind power generation.

Furthermore, the battery cell and the battery device including the same according to the present disclosure may be used in eco-friendly electric vehicles, hybrid vehicles, and other vehicles to prevent climate change by suppressing air pollution and greenhouse gas emissions.

The effects of the present disclosure are not limited to those described above, and other unmentioned effects will be readily apparent to those skilled in the art from the description below.

Only specific examples of implementations of certain embodiments are described. Variations, improvements and enhancements of the disclosed embodiments and other embodiments may be made based on the disclosure of this patent document.

What is claimed is:

1. A battery cell comprising:
a cell housing having an accommodation portion accommodating an electrode assembly;
a vent hole provided in a portion of the cell housing to communicate externally; and
a venting device sealing the vent hole,
wherein the venting device comprises:
a first venting portion communicating with the accommodation portion;
a second venting portion spaced apart from the first venting portion and communicating externally;
a side surface portion in which both open ends are connected to the first venting portion and the second venting portion to form a filtration space; and
a filter portion disposed in the filtration space to filter gas.

2. The battery cell of claim 1, wherein the first venting portion and the second venting portion are ruptured at a preset pressure.

3. The battery cell of claim 2, wherein a first rupture pressure at which the first venting portion is ruptured is set to be lower than a second rupture pressure at which the second venting portion is ruptured.

4. The battery cell of claim 1, wherein the filter portion is disposed spaced apart from the first venting portion.

5. The battery cell of claim 1, wherein the filter portion is a filter filtering hydrofluoric acid (HF) gas.

6. The battery cell of claim 1, further comprising:
an electrode terminal disposed in the cell housing and electrically connected to the electrode assembly, the electrode terminal comprising a first electrode terminal and a second electrode terminal having different polarities; and
a circuit portion controlling current flow between the electrode terminal and the outside according to a state of the venting device.

7. The battery cell of claim 6, wherein the side surface portion comprises an insulating material.

8. The battery cell of claim 6, wherein the circuit portion operates in a first state allowing current flow between the electrode terminal and the outside or in a second state blocking current flow between the electrode terminal and the outside as the venting device is ruptured.

9. The battery cell of claim 6, wherein
one of the first venting portion and the second venting portion is electrically connected to one of the first electrode terminal and the second electrode terminal, and
the other of the first venting portion and the second venting portion is electrically connected to the other of the first electrode terminal and the second electrode terminal through the circuit portion.

10. The battery cell of claim 8, wherein the venting device comprises a connection support portion supporting the filter portion to one of the first venting portion and the second venting portion.

11. The battery cell of claim 10, wherein the connection support portion has electrical conductivity.

12. The battery cell of claim 10, wherein, in the second state, the first venting portion of the venting device, which is ruptured, contacts the connection support portion so as to be electrically connected to the second venting portion.

13. The battery cell of claim 8, wherein
the circuit portion comprises:
a switch electrically connecting an electrode tab having a first polarity to an electrode terminal having the first polarity or blocking the connection; and
a coil electrically connecting the venting device to the electrode tab having the first polarity.

14. The battery cell of claim 13, wherein the switch is opened by a current flowing through the coil in the second state to block the electrical connection between the electrode tab having the first polarity and the electrode terminal having the first polarity.

15. A battery device comprising:
a plurality of battery cells;
a module housing accommodating the plurality of battery cells; and
a controller connected to at least one of the plurality of battery cells and controlling the at least one of the plurality of battery cells,
wherein at least one of the plurality of battery cells comprises one of the battery cells of claim 1, and the controller outputs an error signal or blocks or limits an operation of at least one battery cell, when at least one of a current and a voltage is not detected from at least one of the plurality of battery cells.
